(19) United States
(12) Patent Application Publication
(10) Pub. No.: US 2014/0075326 A1
(43) Pub. Date: Mar. 13, 2014

(54) METHOD AND APPARATUS FOR UPLOADING A FILE

(71) Applicant: Tencent Technology (Shenzhen) Company Limited, Shenzhen (CN)

(72) Inventors: TAO CAO, Shenzhen (CN); JIE HOU, Shenzhen (CN); NINGJUN DOU, Shenzhen (CN); MING HE, Shenzhen (CN); XUHUI LV, Shenzhen (CN)

(73) Assignee: Tencent Technology (Shenzhen) Company Limited, Shenzhen (CN)

(21) Appl. No.: 14/084,909

(22) Filed: Nov. 20, 2013

Related U.S. Application Data
(63) Continuation of application No. PCT/CN2013/082266, filed on Aug. 26, 2013.

(30) Foreign Application Priority Data
Sep. 12, 2012 (CN) 201210335644.7

(51) Int. Cl. G06F 3/0482

(52) U.S. Cl. CPC G06F 3/0482
USPC 715/739

(57) ABSTRACT

Methods and apparatus for uploading a file based on a webkit kernel browser are disclosed herein. A UIWebView control in the webkit kernel browser can be used to monitor a url request. The url request is linked with a triggering button related to a file for uploading on a webpage. It is then determined whether the url request monitored by the UIWebView control contains an agreed protocol header. When the url request is determined that contains the agreed protocol header, the file for uploading is received and uploaded. When it is determined that the url request does not contain the agreed protocol header, the file for uploading is not uploaded. An apparatus for uploading a file based on a webkit kernel browser can include a monitoring module and a determination executing module.

### CROSS-REFERENCES TO RELATED APPLICATIONS

This application is a continuation of PCT Patent Application No. PCT/CN2013/082266, filed on Aug. 26, 2013, which claims priority to Chinese Patent Application No. CN201210335644.7, filed on Sep. 12, 2012, the entire contents of all of which are incorporated herein by reference.

### FIELD OF THE DISCLOSURE

The present disclosure relates to the field of Internet technology and, more particularly, relates to methods and apparatus for uploading a file based on a webkit kernel browser.

### BACKGROUND

An iOS operating apparatus is an apparatus operated by handheld devices and developed by Apple Inc. The iOS and Mac OS X operating apparatus are based on Darwin, which is an open-source operating system published by Apple Inc. in year 2000. The iOS and Mac OS X operating systems are commercial operating systems that are Unix-like. Webkit is an open source browser kernel. Webkit is used as the browser kernel of iOS apparatus. The Webkit kernel has a clear source code structure and a rapid rendering speed.

Currently, the iOS operating apparatus covers a great share in the global smart phone market and in the U.S. smart phone market. As a mobile terminal browser, the user may access mailbox, microblogs, and websites at any time, and file-uploading has become a desired feature. However, the webkit kernel browser of the iOS operating apparatus does not have a file-uploading function. The iOS operating apparatus restricts application programs to access local file systems. In webkit-based browsers (i.e., webkit kernel browsers) for an input tab having the type of “file” on the webpage, the user cannot click on the image of the local file system to upload the file.

### BRIEF SUMMARY OF THE DISCLOSURE

According to various embodiments, there is provided a method for uploading a file based on a webkit kernel browser by using a UIWebView control in the webkit kernel browser to monitor a url request. The url request can be linked with a triggering button related to a file for uploading on a webpage. It is then determined whether the url request monitored by the UIWebView control contains an agreed protocol header. When it is determined that the url request contains the agreed protocol header, the file for uploading is received and uploaded. When it is determined that the url request does not contain the agreed protocol header, the file for uploading is not uploaded.

According to various embodiments, there is also provided an apparatus for uploading a file based on a webkit kernel browser. The apparatus can include a monitoring module, and a determination executing module. The monitoring module can be configured to use a UIWebView control in the webkit kernel browser to monitor a url request. The url request can be linked with a triggering button related to a file for uploading on a webpage. The determination executing module can be configured to determine whether the url request monitored by the UIWebView control contains an agreed protocol header. When the url request is determined that contains the agreed protocol header, the file for uploading is received and uploaded. When it is determined that the url request does not contain the agreed protocol header, the file for uploading is not uploaded.

According to various embodiments, there is also provided a non-transitory computer-readable medium containing computer-executable program. When being executed by a processor, the computer-executable program performs a method for uploading a file based on a webkit kernel browser. The method includes using a UIWebView control in the webkit kernel browser to monitor a url request. The url request is linked with a triggering button related to a file for uploading on a webpage. The method also includes determining whether the url request monitored by the UIWebView control contains an agreed protocol header and, when it is determined that the url request contains the agreed protocol header, receiving and uploading the file for uploading. When it is determined that the url request does not contain the agreed protocol header, the file for uploading is not uploaded.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method for uploading a file in accordance with various embodiments;

FIG. 2 depicts another exemplary method for uploading a file in accordance with various embodiments;

FIG. 3 depicts exemplary upload code in accordance with various embodiments;

FIG. 4 depicts an exemplary apparatus for uploading a file in accordance with various embodiments;

FIG. 5 depicts another exemplary apparatus for uploading a file in accordance with various embodiments;

FIG. 6 depicts an exemplary environment incorporating certain disclosed embodiments; and

FIG. 7 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

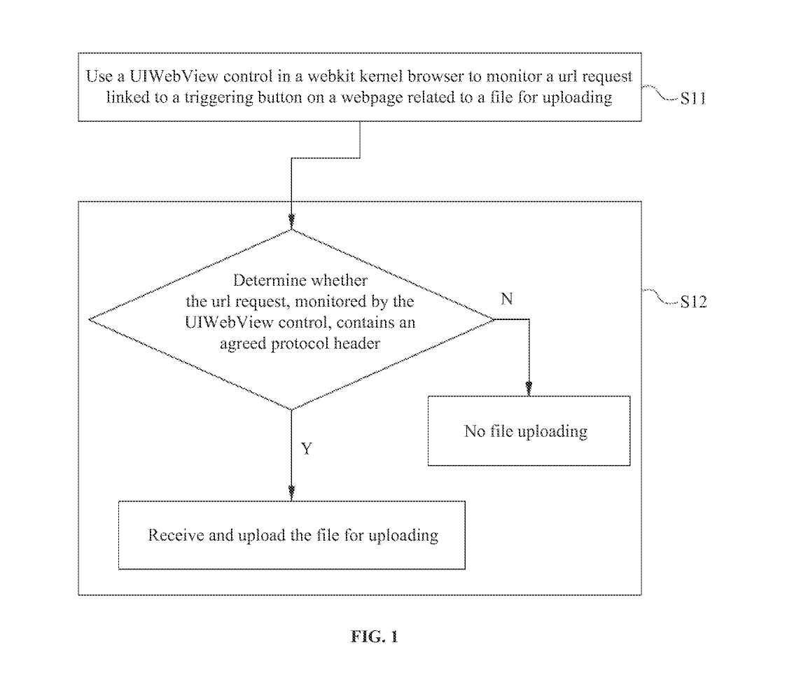

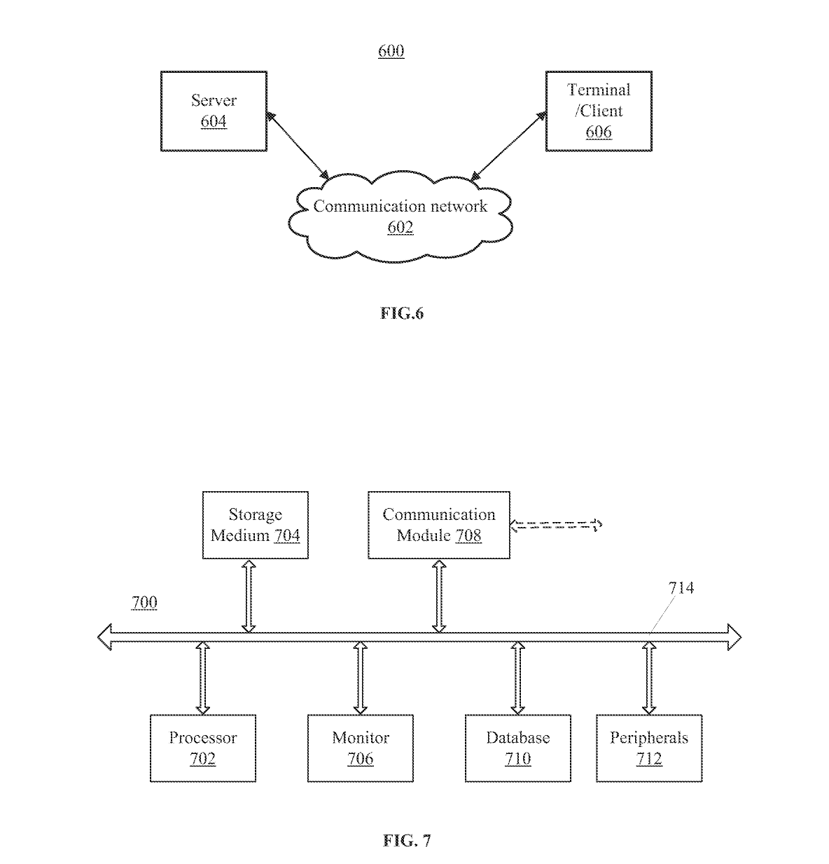

FIGS. 1-5 depict exemplary methods and apparatus for uploading a file based on a webkit kernel browser in accordance with various disclosed embodiments. The exemplary methods and apparatus can be implemented, for example, in an exemplary environment 600 as shown in FIG. 6.

As shown in FIG. 6, the environment 600 can include a server 604, a terminal 606, and a communication network 602. The server 604 and the terminal 606 may be coupled through the communication network 602 for information exchange, for example, Internet searching, webpage browsing, etc. Although only one terminal 606 and one server 604 are shown in the environment 600, any number of terminals 606 or servers 604 may be included, and other devices may also be included.

The communication network 602 may include any appropriate type of communication network for providing network connections to the server 604 and terminal 606 or among multiple servers 604 or terminals 606. For example, the communication network 602 may include the Internet or other types of computer networks or telecommunication networks, either wired or wireless.

A terminal, as used herein, may refer to any appropriate user terminal device with certain computing capabilities, for example, a personal computer (PC), a work station computer, a notebook computer, a car computer (e.g., carrying in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device. In various embodiments, the terms “terminal” and “terminal device” can be used interchangeably. In various embodiments, the terminal 606 can include a browser such as a webkit kernel browser.

A server, as used herein, may refer one or more server computers configured to provide certain server functionalities, for example, search engines and database management. A server may also include one or more processors to execute computer programs in parallel.

The server 604 and the terminal 606 may be implemented on any appropriate computing platform. FIG. 7 shows a block diagram of an exemplary computing system 700 capable of implementing the server 604 and/or the terminal 606. As shown in FIG. 7, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, for example, ROM, RAM, and flash memory modules, and mass storages, for example, CD-ROM, U-disk, removable hard disk, etc. The storage medium 704 may store computer programs for implementing various processes, when executed by the processor 702.

Further, the peripherals 712 may include I/O devices, for example, keyboard and mouse, and the communication module 708 may include network devices for establishing connections through the communication network 602. The database 710 may include one or more databases for storing certain data and for performing certain operations on the stored data, for example, webpage browsing, database searching, etc.

In operation, the terminal 606 may cause the server 604 to perform certain actions, for example, an Internet search or other database operations. The server 604 may be configured to provide structures and functions for such actions and operations. More particularly, the server 604 may include a data searching system for real-time database searching. In various embodiments, a terminal, for example, a mobile terminal involved in the disclosed methods and systems can include the terminal 606.

FIG. 1 depicts an exemplary method for uploading a file in accordance with various embodiments. The exemplary method for uploading the file can be based on a webkit kernel browser.

In Step S11, a UIWebView control in a webkit kernel browser is used to monitor a url request. The url request is linked with a triggering button related to a file for uploading on a webpage

In Step S12, it is determined whether the url request, monitored by the UIWebView control, contains an agreed protocol header. When the url request is determined that contains the agreed protocol header, the file for uploading can be received and uploaded.

When a user needs to upload a file, the user can first click on the triggering button related to the file for uploading on the webpage, for example, by clicking on buttons of “upload”, “browse”, etc. In various embodiments, the triggering button related to the file for uploading can be linked with the url request. When the url request monitored by the UIWebView control in the webkit kernel browser contains the agreed protocol header, it is determined that the user triggers a file uploading request. Note that the agreed protocol header can be pre-set as needed. For example, the agreed protocol header can be pre-set to be http://wbupload or any other suitable protocol headers, without limitation.

The disclosed methods for uploading a file based on the webkit kernel browser uses a form of a link to replace conventional input tabs. When the triggering button is clicked by the user, the UIWebView control in the webkit kernel browser is triggered to monitor a url request and to determine whether the url request contains the agreed protocol header. When it is determined that the url request contains the agreed protocol header, the file for uploading is received and uploaded. Otherwise, when it is determined that the url request does not contain the agreed protocol header, the file for uploading cannot be uploaded. This may solve the problems that the webkit kernel browser for conventional iOS apparatus cannot upload files.

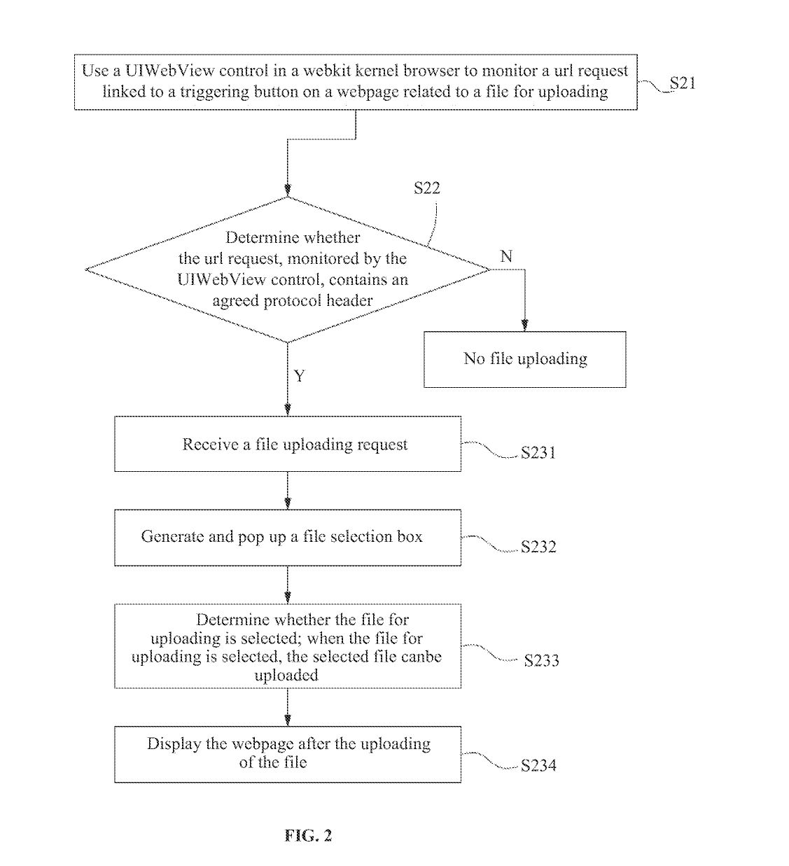

FIG. 2 depicts another exemplary method for uploading a file in accordance with various embodiments. The exemplary method for uploading the file can be based on a webkit kernel browser.

In Step S21, a UIWebView control in a webkit kernel browser is used to monitor a url request. The url request is linked with a triggering button related to a file for uploading on a webpage

In Step S22, it is determined whether the url request, monitored by the UIWebView control, contains agreed protocol header. When the url request is determined that contains the agreed protocol header, Step S23 (including, e.g., Step 231, Step 232, Step 233, and Step 234) can be performed to receive and upload the file for uploading. Otherwise, when the url request is determined that does not contain the agreed protocol header, the file for uploading cannot be uploaded.

In Step 231, a file uploading request is received.

In various embodiments, the url request, linked to the triggering button related to the file for uploading, can be, for example, http://wbupload://somehost/somepath?somequery&cookiejs=func1&successjs=func2&positionjs=func3, where http://wbupload is the agreed protocol header; somehost/somepath?somequery & is a post request url related to file uploading; http://wbupload://somehost/somepath?somequerv&cookiejs=func1&successjs=func2&positionjs=func3 is a fixed format with each of func1, func2, and func3 (e.g., js function names with no parentheses) having a specific name delivered depending on a server.

In this case, the UIWebView control can be used to call the func1 js function to obtain cookie values used for sending the file uploading request. The obtained cookies can be used to obtain the user's identity and/or other suitable information including, for example, which user is performing the file uploading.

In Step S232, a file selection box can be generated and popped up for selecting a file. For example, the UIWebView control can be used to call the func3 js function to obtain a js element object. The client can design own algorithms to calculate a position for the file selection box to point to.

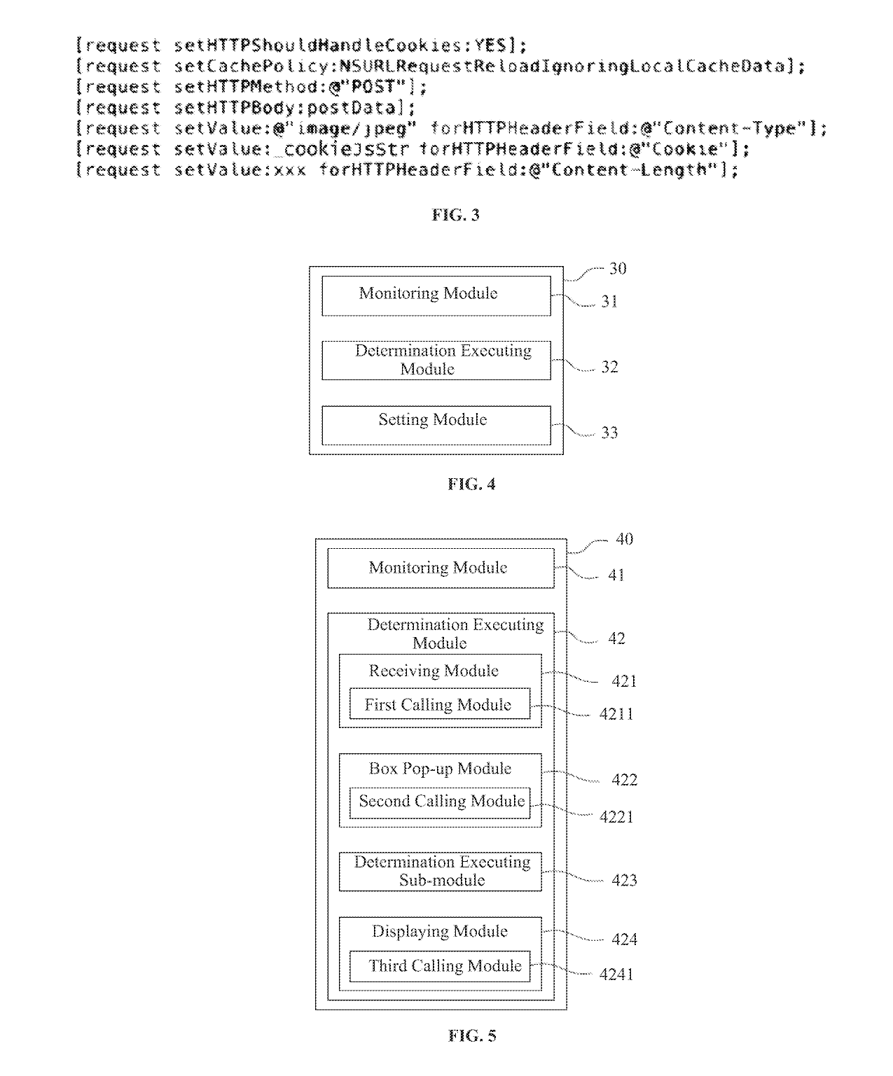

In Step S233, it is determined whether the file for uploading is selected. When the file for uploading is selected, the selected file for uploading can then be uploaded. After the file is selected and the uploading starts, the client (of the webkit kernel browser) may provide an upload interface. Exemplary upload code is shown in FIG. 3 for illustration purposes. Of course, the present disclosure is not limited thereto.

In Step S234, after the file uploading, the webpage is displayed.

In this case, after the file is successfully uploaded, the UIWebView control can be used to call the related func2 js function to display the webpage following the upload of the file. For example, a response body (in a text format) can be used as a parameter of func2 js function. By calculating func2 js function, the webpage can be displayed after the uploading of the file.

The disclosed methods for uploading a file based on the webkit kernel browser uses a form of a link to replace conventional input tabs. When the triggering button is clicked by the user, the UIWebView control in the webkit kernel browser is triggered to monitor a url request and to determine whether the url request contains the agreed protocol header. When it is determined that the url request contains the agreed protocol header, the file for uploading is received and uploaded. Otherwise, when it is determined that the url request does not contain the agreed protocol header, the file for uploading cannot be uploaded. This may solve the problems that the webkit kernel browser for conventional iOS apparatus cannot upload files.

FIG. 4 depicts an exemplary apparatus 30 for uploading a file in accordance with various embodiments. The exemplary apparatus for uploading the file can be based on a webkit kernel browser. The exemplary apparatus 30 can include a monitoring module 31 and/or a determination executing module 32.

The monitoring module 31 can be configured to use a UIWebView control in a webkit kernel browser to monitor a url request linked to a triggering button on a webpage that is related to a file for uploading.

The determination executing module 32 can be configured to determine whether the url request, monitored by the UIWebView control, contains an agreed protocol header. When the url request is determined that contains the agreed protocol header, the file for uploading can be received and uploaded.

When a user needs to upload a file, the user can first click on the triggering button related to the file for uploading on the webpage, for example, by clicking on buttons of “upload”, “browse”, etc. In various embodiments, the triggering button related to the file for uploading can be linked with the url request. When the monitoring module 31 monitors the url request that contains the agreed protocol header, it is determined that the user triggers a file uploading request. Note that the agreed protocol header can be pre-set as needed by a setting module 33. For example, the agreed protocol header can be pre-set to be http://wbupload or any other suitable protocol headers, without limitation.

The disclosed apparatus for uploading a file based on a webkit kernel browser uses a monitoring module to monitor the url request. The determination executing module is used to determine whether the url request contains the agreed protocol header. When it is determined that the url request contains the agreed protocol header, the file for updating can be received and uploaded. Otherwise, when it is determined that the url request does not contain the agreed protocol header, the file uploading cannot be performed. This solves the problems that the webkit kernel browser for conventional iOS apparatus cannot upload files.

FIG. 5 depicts an exemplary apparatus 40 for uploading a file in accordance with various embodiments. The exemplary apparatus for uploading the file can be based on a webkit kernel browser. The exemplary apparatus 40 can include a monitoring module 41 and/or a determination executing module 42.

The monitoring module 41 can be configured to use a UIWebView control in a webkit kernel browser to monitor a url request linked to a triggering button on a webpage that is related to a file for uploading.

The determination executing module 42 can be configured to determine whether the url request, monitored by the UIWebView control, contains the agreed protocol header. When the url request is determined that contains the agreed protocol header, the file for uploading can be received and uploaded. Otherwise, when the url request is determined that does not contain the agreed protocol header, the file for uploading cannot be uploaded.

The determination executing module 42 can include a receiving module 421 used to receive a file uploading request. In various embodiments, the url request, linked to the triggering button related to the file for uploading, can be, for example, http://wbupload://somehost/somepath?somequery&cookiejs=func1&successjs=func2&positionjs=func3, where http://wbupload is the agreed protocol header; somehost/somepath?somequery & is a post request url related to file uploading; http://wbupload://somehost/somepath?somequery&cookiejs=func1&successjs=func2&positionjs=func3 is a fixed format with each of func1, func2, and func3 (js function name with no parentheses) having a specific name delivered depending on a server.

The receiving module 421 can include a first calling module 4211 configured to use the UIWebView control to call the func3 js function to obtain cookie values used for sending the file uploading request.

The determination executing module 42 can also include a box pop-up module 422 configured to generate and pop up a file selection box.

Optionally, the box pop-up module 422 can include a second calling module 4221 configured to use the UIWebView control to call related js function to calculate a position for the file selection box to point to.

The determination executing module 42 can further include a determination executing sub-module 423 configured to determine whether the file for uploading is selected. When the file for uploading is selected, the selected file can then be uploaded.

The determination executing module 42 can further include a displaying module 424 configured to display the webpage after the uploading of the file.

The displaying module 424 can include a third calling module 4241 configured to use the UIWebView control to call related js function to display the webpage following the uploading of the file.

The disclosed apparatus for uploading a file based on a webkit kernel browser uses a monitoring module to monitor the url request. The determination executing module is used to determine whether the url request contains the agreed protocol header. When it is determined that the url request contains the agreed protocol header, the file for updating can be received and uploaded. Otherwise, when it is determined that the url request does not contain the agreed protocol header, the file uploading cannot be performed. This solves the problems that the webkit kernel browser for conventional iOS apparatus cannot upload files.

It should be noted that, in the present disclosure each embodiment is progressively described, i.e., each embodiment is described and focused on difference between embodiments. Similar and/or the same portions between various embodiments can be referred to with each other. In addition, exemplary apparatus is described with respect to corresponding methods.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a” does not exclude other elements included in the process, method, article, or apparatus having those elements.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods for uploading a file based on the webkit kernel browser uses a form of a link to replace conventional input tabs. When the triggering button is clicked by the user, the UIWebView control in the webkit kernel browser is triggered to monitor a url request and to determine whether the url request contains the agreed protocol header. When it is determined that the url request contains the agreed protocol header, the file for uploading is received and uploaded. Otherwise, when it is determined that the url request does not contain the agreed protocol header, the file for uploading cannot be uploaded. This may solve the problems that the webkit kernel browser for conventional iOS apparatus cannot upload files.

The disclosed apparatus for uploading a file based on a webkit kernel browser uses a monitoring module to monitor the url request. The determination executing module is used to determine whether the url request contains the agreed protocol header. When it is determined that the url request contains the agreed protocol header, the file for updating can be received and uploaded. Otherwise, when it is determined that the url request does not contain the agreed protocol header, the file uploading cannot be performed. This solves the problems that the webkit kernel browser for conventional iOS apparatus cannot upload files.

What is claimed is:

1. A method for uploading a file based on a webkit kernel browser comprising:
using a UIWebView control in the webkit kernel browser to monitor a url request, wherein the url request is linked with a triggering button related to a file for uploading on a webpage;
determining whether the url request monitored by the UIWebView control contains an agreed protocol header; and
receiving and uploading the file for uploading, when it is determined that the url request contains the agreed protocol header, wherein the file for uploading is not uploaded, when it is determined that the url request does not contain the agreed protocol header.

2. The method of claim 1, wherein, prior to using the UIWebView control to monitor the url request, the method further comprises:
setting the agreed protocol header.

3. The method of claim 1, wherein the receiving and uploading of the file comprises:
receiving a file uploading request;
generating and popping up a file selection box for selecting a file;
determining whether the file for uploading is selected;
uploading the selected file for uploading, when the file for uploading is determined to be selected; and
displaying the webpage after the uploading of the file.

4. The method of claim 3, wherein the receiving of the file uploading request comprises:
using the UIWebView control to call a first js function to obtain a cookie value used for sending the file uploading request.

5. The method of claim 3, wherein the generating and popping up of the file selection box comprises:
using the UIWebView control to call a second js function to calculate a position for the file selection box to point to.

6. The method of claim 3, wherein the displaying of the webpage after the uploading of the file comprises:
using the UIWebView control to call a third js function to display the webpage following the uploading of the file.

7. An apparatus for uploading a file based on a webkit kernel browser comprising:
a monitoring module, configured to use a UIWebView control in the webkit kernel browser to monitor a url request, wherein the url request is linked with a triggering button related to a file for uploading on a webpage; and
a determination executing module, configured to determine whether the url request monitored by the UIWebView control contains an agreed protocol header, wherein the file for uploading is received and uploaded, when the url request is determined that contains the agreed protocol header, or the file for uploading is not uploaded, when it is determined that the url request does not contain the agreed protocol header.

8. The apparatus of claim 7, further comprising:
a setting module, configured to set the agreed protocol header.

9. The apparatus of claim 7, wherein the determination executing module comprises:
a receiving module, configured to receive a file uploading request;
a box pop-up module, configured to generate and pop up a file selection box for selecting a file;
a determination executing sub-module, configured to determine whether the file for uploading is selected, wherein, when the file for uploading is determined to be selected, the selected file for uploading is uploaded; and
a displaying module, configured to display the webpage after the uploading of the file.

10. The apparatus of claim 9, wherein the receiving module comprises:
a first calling module, configured to use the UIWebView control to call a first js function to obtain a cookie value used for sending the file uploading request.

11. The apparatus of claim 9, wherein the box pop-up module comprises:
a second calling module, configured to use the UIWebView control to call a second js function to calculate a position for the file selection box to point to.

12. The apparatus of claim 9, wherein the displaying module comprises:
a third calling module, configured to use the UIWebView control to call a third js function to display the webpage following the uploading of the file.

13. A non-transitory computer-readable medium containing computer-executable program for, when being executed by a processor, uploading a file based on a webkit kernel browser, the method comprising:
using a UIWebView control in the webkit kernel browser to monitor a url request, wherein the url request is linked with a triggering button related to a file for uploading on a webpage;
determining whether the url request monitored by the UIWebView control contains an agreed protocol header; and
receiving and uploading the file for uploading, when it is determined that the url request contains the agreed protocol header, wherein the file for uploading is not uploaded, when it is determined that the url request does not contain the agreed protocol header.

14. The computer-readable medium of claim 13, wherein, prior to using the UIWebView control to monitor the url request, the method further comprises:
setting the agreed protocol header.

15. The computer-readable medium of claim 13, wherein the receiving and uploading of the file comprises:
receiving a file uploading request;
generating and popping up a file selection box for selecting a file;
determining whether the file for uploading is selected;
uploading the selected file for uploading, when the file for uploading is determined to be selected; and
displaying the webpage after the uploading of the file.

16. The computer-readable medium of claim 15, wherein the receiving of the file uploading request comprises:
using the UIWebView control to call a first js function to obtain a cookie value used for sending the file uploading request.

17. The computer-readable medium of claim 15, wherein the generating and popping up of the file selection box comprises:
using the UIWebView control to call a second js function to calculate a position for the file selection box to point to.

18. The computer-readable medium of claim 15, wherein the displaying of the webpage after the uploading of the file comprises:
using the UIWebView control to call a third js function to display the webpage following the uploading of the file.
